(19) United States
(12) Patent Application Publication
(10) Pub. No.: US 2013/0034128 A1
(43) Pub. Date: Feb. 7, 2013

(54) ECHO CANCELLATION REPEATER OPERATION IN THE ABSENCE OF AN INPUT SIGNAL

(71) Applicants: Dhananjay Ashok Gore, Bangalore (IN); Gwendolyn Denise Barriac, Encinitas, CA (US); Michael Mao Wang, San Diego, CA (US); Tao Tian, San Diego, CA (US)

(72) Inventors: Dhananjay Ashok Gore, Bangalore (IN); Gwendolyn Denise Barriac, Encinitas, CA (US); Michael Mao Wang, San Diego, CA (US); Tao Tian, San Diego, CA (US)

(73) Assignee: QUALCOMM INCORPORATED, San Diego, CA (US)

(21) Appl. No.: 13/204,397

(22) Filed: Aug. 5, 2011

(51) Int. Cl. H04L 25/20

(52) U.S. Cl. 375/211

(57) ABSTRACT

A wireless repeater introduces a low level noise to the signal path of the repeater where the introduced noise is used to facilitate channel estimation. The introduced low power level noise may be added to the receive signal or to the transmit signal. The low power noise signal ensures that the repeater always has a reference signal for performing channel estimation, even when the repeater is not receiving any incoming signal traffic. In one embodiment, a low noise signal is inserted to the transmit circuit of the repeater. In another embodiment, the repeater is configured to increase the noise figure of the receive circuit where the detected noise figure acts as a receive signal.

### BACKGROUND

1. Field

This disclosure generally relates to repeaters in wireless communication systems, and in particular, to a method and apparatus for inserted pilot power control in an echo cancellation repeater.

2. Background

Wireless communication systems and techniques have become an important part of the way we communicate. However, providing coverage can be a significant challenge to wireless service providers. One way to extend coverage is to deploy repeaters.

In general, a repeater is a device that receives a signal, amplifies the signal, and transmits the amplified signal. FIG. 1 shows a basic diagram of a repeater 110, in the context of a cellular telephone system. Repeater 110 includes a donor antenna 115 as an example network interface to network infrastructure such as a base station 125. Repeater 110 also includes a server antenna 120 (also referred to as a “coverage antenna”) as a mobile interface to mobile device 130. In operation, donor antenna 115 is in communication with base station 125, while server antenna 120 is in communication with mobile devices 130.

In repeater 110, signals from base station 125 are amplified using forward link circuitry 135, while signals from mobile device 130 are amplified using reverse link circuitry 140. Many configurations may be used for forward link circuitry 135 and reverse link circuitry 140.

There are many types of repeaters. In some repeaters, both the network and mobile interfaces are wireless; while in others, a wired network interface is used. Some repeaters receive signals with a first carrier frequency and transmit amplified signals with a second different carrier frequency, while others receive and transmit signals using the same carrier frequency. For “same frequency” repeaters, one particular challenge is managing the feedback that occurs since some of the transmitted signal can leak back to the receive circuitry and be amplified and transmitted again.

Existing repeaters manage feedback using a number of techniques; for example, the repeater is configured to provide physical isolation between the two antennae, filters are used, or other techniques may be employed.

### SUMMARY

Systems, apparatuses, and methods disclosed herein allow for enhanced repeater capability. In one embodiment, a method for providing echo cancellation in a wireless repeater in a wireless communication system including generating an auxiliary signal with a low power level; transmitting the auxiliary signal on a transmitting antenna of the repeater where the auxiliary signal is transmitted with or without an intended transmit signal; receiving a receive signal at a receiving antenna of the repeater where the receive signal includes at least a feedback signal being a signal fed back to the receiving antenna on a feedback channel between the transmitting antenna and the receiving antenna and the feedback signal includes at least the auxiliary signal transmitted on the transmitting antenna of the repeater and fed back to the receiving antenna through the feedback channel; cancelling the feedback signal from the receive signal using a currently available feedback channel estimate and generating an echo cancelled signal; and generating an updated feedback channel estimate using the receive signal and a transmit signal based on the echo cancelled signal.

According to another embodiment of the present invention, a wireless repeater having a receiving antenna and a transmitting antenna includes an auxiliary signal construction block configured to generate an auxiliary signal with a low power level where the auxiliary signal is transmitted on the transmitting antenna of the repeater with or without an intended transmit signal; an echo canceller configured to receive a receive signal at the receiving antenna of the repeater where the receive signal includes at least a feedback signal being a signal fed back to the receiving antenna on a feedback channel between the transmitting antenna and the receiving antenna and the feedback signal includes at least the auxiliary signal transmitted on the transmitting antenna of the repeater and fed back to the receiving antenna through the feedback channel and the echo canceller is configured to cancel the feedback signal from the receive signal using a currently available feedback channel estimate and to generate an echo cancelled signal; and a channel estimation block configured to generate an updated feedback channel estimate using the receive signal and a transmit signal based on the echo cancelled signal.

According to embodiments of the present invention, the auxiliary signal may be a signal in the digital or analog domain. Furthermore, in some embodiments, the auxiliary signal may be added to the signal path of the repeater at any point between the receiving antenna and the transmitting antenna of the repeater.

### BRIEF DESCRIPTION OF THE DRAWINGS

FIG. 1 is a simplified diagram of a repeater according to the prior art.

FIG. 2 shows a diagram of a repeater environment according to some embodiments of the present invention.

FIG. 3 is a block diagram of a repeater incorporating a pilot insertion system according to one embodiment of the present invention.

FIG. 4 is a block diagram of a repeater according to one embodiment of the present invention.

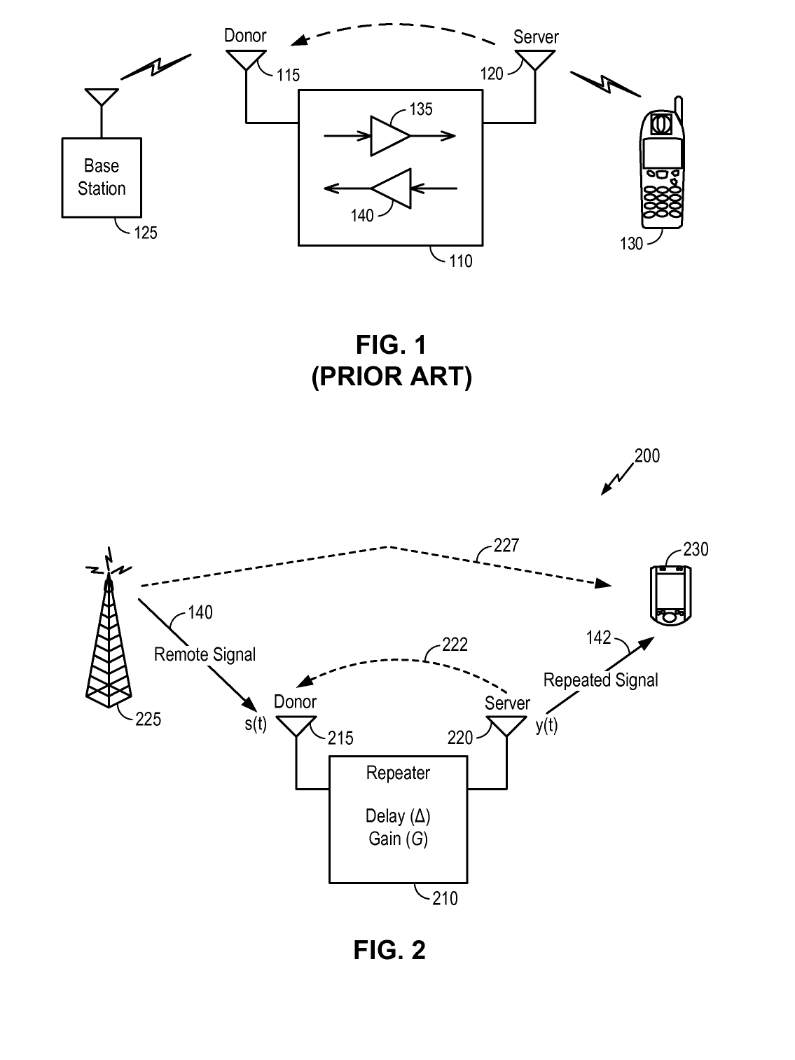

### DETAILED DESCRIPTION

The nature, objectives, and advantages of the disclosed method and apparatus will become more apparent to those skilled in the art after considering the following detailed description in connection with the accompanying drawings.

Prior art repeaters such as those described above may provide significant advantages for cellular telephone or similar networks. However, existing repeater configurations may not be suitable for some applications. For example, existing repeater configurations may not be suitable for indoor coverage applications (e.g., repeating signals for a residence or business environment) which may require substantially more isolation between the repeater's antennas. Moreover, in some traditional repeater implementations, the target is to achieve as high a gain as reasonable while maintaining a stable feedback loop (loop gain less than unity). However, increasing the repeater gain renders isolation more difficult due to the increased signal leaking back into the donor antenna. In general, loop stability demands require that the signal leaking back into the donor antenna from the coverage antenna be much lower than the remote signal (the signal to be repeated). The maximum achievable signal to interference/noise ratio (SINR) at the output of the repeater is then the same as the SINR at the input to the repeater. High gain and improved isolation from two contradicting demands required for modern day repeaters, especially those for indoor applications.

FIG. 2 shows a diagram of an operating environment 200 for a repeater 210 according to embodiments of the present invention. In FIG. 2, a remote signal 140 from a base station 225 is intended for a mobile device 230. A repeater, such as repeater 210, may be used in environment 200 if an un-repeated signal along the path 227 between base station 225 and mobile device 230 would not provide sufficient signal for effective voice and/or data communications received at mobile device 230. Repeater 210 with a gain G and a delay A is configured to repeat a signal received from base station 225 on a donor antenna 215 (“the receiving antenna”) and amplify and transmit the signal to mobile device 230 using a server antenna 220 (“the transmitting antenna”). Repeater 210 includes forward link circuitry for amplifying and transmitting signals received from the base station 225 to mobile device 230 through donor antenna 215 and server antenna 220. Repeater 210 may also include reverse link circuitry for amplifying and transmitting signals from mobile device 230 back to base station 225. At repeater 210, the remote signal s(t) is received as an input signal and the remote signal s(t) is repeated as a repeated or amplified signal y(t) where y(t)=\sqrt{G}s(t−Δ). Ideally, the gain G would be large, the inherent delay Δ of the repeater would be small, the input SINR would be maintained at the output of repeater 210 (this can be of particular importance for data traffic support), and only desired carriers would be amplified.

In practice, the gain of repeater 210 is limited by the isolation between donor antenna 215 and server antenna 220. If the gain is too large, the repeater can become unstable due to signal leakage. Signal leakage refers to the phenomenon where a portion of the signal that is transmitted from one antenna (in FIG. 2, server antenna 220) is received by the other antenna (in FIG. 2, donor antenna 215), as shown by the feedback path 222 in FIG. 2. Without interference cancellation or other techniques, the repeater would amplify this feedback signal, also referred to as the leakage signal, as part of its normal operation, and the amplified feedback signal would again be transmitted by server antenna 220. The repeated transmission of the amplified feedback signal due to signal leakage and high repeater gain can lead to repeater instability. Additionally, signal processing in repeater 210 has an inherent non-negligible delay Δ. The output SINR of the repeater is dependent on RF non-linearities and other signal processing. Thus, the aforementioned ideal repeater operational characteristics are often not attained. Finally, in practice, the desired carriers can vary depending on the operating environment or market in which the repeater is deployed. It is not always possible to provide a repeater that amplifies only the desired carriers.

In a same-frequency repeater, the incoming signal is retransmitted on the same frequency at which it is received. In cases where high gain is desired than there is isolation in the antennas, interference cancellation is often used to increase the stability of the repeater and increase the overall gain.

In embodiments of the present invention, a wireless repeater employs interference cancellation or echo cancellation to improve the isolation between the repeater's donor antenna (“the receiving antenna”) and the coverage antenna (“the transmitting antenna”). Interference cancellation is accomplished by actively cancelling out the transmit signal received on the repeater's own receive signal, referred to as the “leakage signal” or the “feedback signal.” In some cases, interference cancellation is carried out in baseband, that is in the digital domain. Baseband interference cancellation is accomplished by storing a digital reference of the signal to be transmitted and using this digital reference to estimate the feedback channel. The feedback channel estimate is then use to estimate the feedback signal so as to actively cancel the leakage signal.

More specifically, the echo cancellation process involves estimating the feedback channel using the transmit signal as a reference signal, convolving the feedback channel estimate with the transmit signal to generate a feedback signal estimate, and applying the feedback signal estimate to cancel the undesired feedback signal in the receive signal. Effective echo cancellation requires very accurate channel estimation of the leakage channel. In general, the more accurate the channel estimate, the higher the cancellation and hence the higher the effective isolation. Herein, “interference cancellation” or “echo cancellation” refers to techniques that reduce or eliminate the amount of leakage signal between repeater antennas; that is, “interference cancellation” refers to partial or complete cancellation of the leakage signal.

However, in normal operation of the repeater, the repeater may not receive any incoming input signal and therefore the repeater is not transmitting any transmit signal. When there is no transmit signal, no channel estimation can be performed and thus no feedback channel estimate can be generated for the purpose of echo cancellation. For instance, for repeaters amplifying uplink signals, it is often the case that the mobile unit will transmit intermittently in time. In such situations, whenever the mobile is not transmitting, the repeater does not have a reference signal and thus no channel estimate can be generated or the previous channel estimate is not updated. When the mobile unit starts to transmit and if the repeater does not have a channel estimate, the repeater cannot begin echo cancellation immediately. This leads to lower gains and delays in amplified transmission. Because uplink data may be sent in consecutive spurts and silences, in order to ensure good quality amplification, it is desirable that the echo cancellation repeater always has updated channel estimates.

According to embodiments of the present invention, a wireless repeater employing interference cancellation or echo cancellation introduces a low level noise signal, also referred to as a “low noise signal” or an “auxiliary signal”, to either the receive signal or to the transmit signal where the introduced noise is used to facilitate channel estimation. More specifically, the introduced low level noise at the receive or transmit signal of the repeater ensures that the repeater always has a reference signal for performing channel estimation, even when the repeater is not receiving any incoming signal traffic. Accordingly, the repeater may estimate the feedback channel continuously and carry out echo cancellation continuously with updated feedback channel estimates, regardless of the frequency or behavior of the repeater input signal so that interruption of service is avoided.

In embodiments of the present invention, the low noise signal is an analog noise signal or a digital noise signal and the low noise signal can be introduced at any point in the receive and transmit signal chain of the repeater. For instance, the low noise signal may be introduced to the analog front end receive or transmit circuitry. The low noise signal may also be introduced in the digital baseband to the receive signal or to the transmit signal.

In one embodiment, the low noise signal is introduced by adding a “low noise signal” or an “auxiliary signal” to the transmit circuit. That is, the low level noise signal is added to the transmit circuit so that the low level noise is transmitted together with an intended transmit signal when there is an intended transmit signal, or alone, when there is no intended transmit signal. In one embodiment, the low noise signal is added to the transmit signal continuously, that is, in the presence of or in the absence of an intended transmit signal. The low noise signal, so transmitted, is used by the repeater in estimating the feedback channel.

In another embodiment, the low level noise signal is introduced by configuring the receiver circuitry to increase the receiver circuitry's noise figure, so that the repeater operates as if there is always a non-zero signal being received. The low level noise from the receiver circuitry becomes the repeater input signal when there is no intended input signal. In this manner, the repeater can continue to generate updated channel estimates even in the absence of an intended input signal.

In a first embodiment of the present invention, the repeater inserts a low noise signal to the transmit circuit so that the low noise signal is transmitted by the repeater with or without an intended transmit signal. When there is no “intended” repeater input signal from a mobile unit or from a base station, the repeater receives the low noise signal transmitted from the transmitter. The low noise signal acts as the repeater input signal. The repeater generates a transmit signal based on its input signal where the transmit signal is used as the reference signal in channel estimation. In one embodiment, the low noise signal is added to the transmitter output continuously, that is, in the presence or in the absence of an intended transmit signal. In another embodiment, the low noise signal is added to the transmitter output only when there is no intended transmit signal. In this manner, the addition of the low noise signal introduces less noise to the overall communication system.

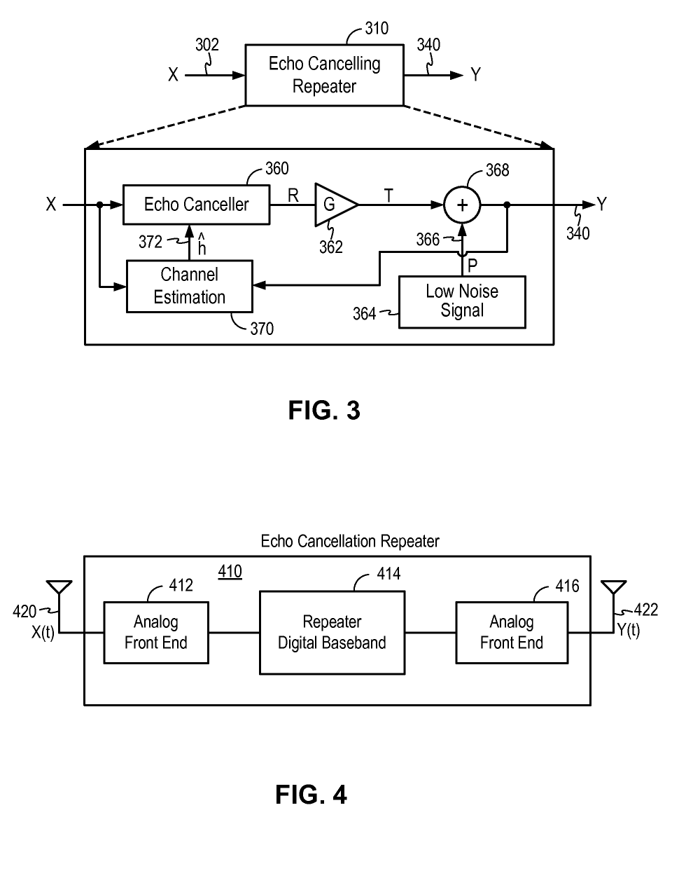

FIG. 3 is a block diagram of a repeater incorporating an auxiliary signal insertion system according to one embodiment of the present invention. An echo cancelling repeater 310 receives a receive signal or an input signal X (node 302) and generates an output signal or amplified signal Y (node 340) to be transmitted. In the echo cancelling repeater 310, an auxiliary signal construction block 364 is provided to introduce a low noise signal P to the output signal Y. More specifically, in echo cancelling repeater 310, an echo canceller 360 receives the input signal X and generates an echo-cancelled signal R. The echo-cancelled signal R is coupled to a gain block 362 to be amplified. The gain block 362 generates the desired transmit signal T which is derived from the input signal X. The transmit signal T may be a single carrier signal or a multi-carrier signal. A low noise signal P (node 366) is generated by the auxiliary signal construction block 364. The low noise signal P is added to the transmit circuit and summed with the desired transmit signal T (summer 368) to generate the output transmit signal Y. The output transmit signal Y is thus a composite transmit signal where Y=T+P. The low noise signal P is perceived as noise by devices receiving the composite transmitted signal from the repeater. The output transmit signal Y is coupled to a channel estimation block 370 which uses the output transmit signal Y as a reference signal and also uses the input signal X to generate a channel estimate ĥ 372. The channel estimate ĥ 372 is provided to the echo canceller 360 for performing echo cancellation.

In accordance with embodiments of the present invention, the low noise signal P generated by the auxiliary signal construction block 364 is added to the transmit circuit to be combined with the desired transmit signal T, if any, to form the composite transmit signal Y. In one embodiment, the low noise signal P is added to the desired transmit signal T continuously, that is, in the presence of intended transmit signal T or in the absence thereof. In operation, in the absence of an intended input signal, there is no intended transmit signal. However, the low noise signal will be transmitted from the echo cancelling repeater 310 to serve as the transmit signal. The low noise signal transmitted by the transmitting antenna is received by the receiving antenna of the repeater as the receive signal. The receive signal thus received, which is the feedback low noise signal, can then be used by the repeater for channel estimation.

In an alternate embodiment of the present invention, the low noise signal P is added only in the absence of intended transmit signal T. That is, when the echo cancelling repeater 310 is not receiving any intended receive signal, then there is no intended transmit signal and the auxiliary signal construction block 364 will be activated to introduce the low noise signal P to the transmit circuit as the transmit signal. In this manner, the low noise signal is added only in the absence of any intended input signal and less noise is introduced to the communication environment.

In one embodiment, the low noise signal is a signal with white noise that is about 30 dB above thermal noise.

In a second embodiment of the present invention, the repeater is configured to insert a low noise signal to the receive signal so that the repeater operates as if it is always receiving an input signal even in the absence of an intended input signal. In one embodiment, the repeater is configured to increase the noise figure of the analog receiver circuitry where the increased noise figure acts as the low noise signal. More specifically, the analog receiver circuitry is configured so as to increase the background noise or the thermal noise to a level within the input range of the analog-to-digital converter used to digitize the input signal. In this manner, even in the absence of an actual input signal, the repeater sees the increased noise, and uses that as an input signal. FIG. 4 is a block diagram of a repeater according to one embodiment of the present invention. An echo cancellation repeater 410 includes first and second antennas 420 and 422 for receiving and transmitting receive and transmit signals. The echo cancellation repeater 410 includes a first analog front end circuit 412, a repeater digital baseband block 414 and a second analog front end circuit 416. The analog front end circuits 412, 416 receive analog input signals from the antennas, filter and process the signals and digitize the signals for the repeater digital baseband block 414. The analog front end circuits 412, 416 also receive digital transmit signal from the repeater baseband block 414, convert the digital transmit signal to analog format for transmission onto the antennas 420, 422.

In a conventional repeater, the analog-to-digital converters of the analog front end circuits are configured so that the ADC input range is well above the noise floor. However, in the repeater of the present invention, the front end circuit 412 or 416 is configured so that the thermal noise is raised to be within the ADC input range so that the thermal noise acts as a “substitute” input signal, and the feedback channel can be estimated as usual. In one embodiment, the analog gain of the analog front end circuit is increased to bring the thermal noise within the ADC input range. That is, the gain of the RF receiver circuit in the front end circuit is manipulated to artificially raise the background noise (the thermal noise). For example, the thermal noise may be around −95 dB. The analog gain of the repeater may be manipulated to increase the thermal noise to −60 dB so that the thermal noise level is now within the input range of the ADC and the ADC is always receiving input signals, even in the absence of an intended input signal. In this manner, the repeater will always have an input signal when means the repeater will always have a transmit signal which can be used as the reference signal for channel estimation.

In conventional repeaters, raising the noise figure would be deemed undesirable for normal repeater operation and is something that should be avoided. However, in the repeater of the present invention, a low noise signal derived by raising the background noise is advantageously applied as a substitute input signal in a repeater to support channel estimation and echo cancellation. The use of an increased noise figure, or raising the background noise (thermal noise), in order to provide a low noise signal for the purpose of channel estimation has not been appreciated by those skilled in the art prior to the present invention.

In the above-described embodiments, a low noise signal is introduced to the transmit circuit of the repeater either continuously or in the absence of an intended input signal. Furthermore, in the above-described embodiments, a low noise signal is introduced to the receive circuit of the repeater by raising the noise figure of the analog receiver circuitry of the repeater. The above-described embodiments are illustrative only and are not intended to be limiting. In embodiments of the present invention, the low noise signal can be added at any point in the receive or transmit signal path of the repeater. In some embodiments, the low noise signal is introduced as a digital low noise signal in the repeater digital baseband block. That is, the low noise signal is added to the digital receive circuit or the digital transmit circuit. The low noise signal can also be introduced as an analog low noise signal in the analog receive circuit or the analog transmit circuit.

The communication system in which the repeater of the present invention can be deployed includes various wireless communication networks based on infrared, radio, and/or microwave technology. Such networks can include, for example, a wireless wide area network (WWAN), a wireless local area network (WLAN), a wireless personal area network (WPAN), and so on. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, and so on. A CDMA network may implement one or more radio access technologies (RATs) such as CDMA2000, Wideband-CDMA (W-CDMA), and so on. CDMA2000 includes IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). CDMA2000 is described in documents from a consortium named “3rd Generation Partnership Project 2” (3GPP2). 3GPP and 3GPP2 documents are publicly available. A WLAN may be an IEEE 802.11x network, and a WPAN may be a Bluetooth network, an IEEE 802.15x, or some other type of network. The systems and techniques described herein may also be used for any combination of WWAN, WLAN and/or WPAN.

Those skilled in the art will understand that information and signals may be represented using any of a variety of different technologies and techniques. For example: data, information, signals, bits, symbols, chips, instructions, and commands may be referenced throughout the above description. These may be represented by voltages, currents, electromagnetic waves, magnetic fields or particles, optical fields or particles, or any combination thereof.

In one or more of the above-described embodiments, the functions and processes described may be implemented in hardware, software, firmware, or any combination thereof. If implemented in software, the functions may be stored on one or more instructions or code on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. The term “control logic” used herein applies to software (in which functionality is implemented by instructions stored on a machine-readable medium to be executed using a processor), hardware (in which functionality is implemented using circuitry (such as logic gates), where the circuitry is configured to provide particular output for particular input, and firmware (in which functionality is implemented using re-programmable circuitry), and also applies to combinations of one or more of software, hardware, and firmware.

For a firmware and/or software implementation, the methodologies may be implemented with modules (e.g., procedures, functions, and so on) that perform the functions described herein. Any machine readable medium tangibly embodying instructions may be used in implementing the methodologies described herein. For example, software codes may be stored in a memory, for example the memory of mobile station or a repeater, and executed by a processor, for example the microprocessor of modem. Memory may be implemented within the processor or external to the processor. As used herein the term “memory” refers to any type of long term, short term, volatile, nonvolatile, or other memory and is not to be limited to any particular type of memory or number of memories, or type of media upon which memory is stored. “Computer readable medium,” “storage medium” and the like do not refer to transitory propagating signals.

Moreover, the previous description of the disclosed implementations is provided to enable any person skilled in the art to make or use the present invention. Various modifications to these implementations will be readily apparent to those skilled in the art, and the generic principles defined herein may be applied to other implementations without departing from the spirit or scope of the invention. Thus, the present invention is not intended to be limited to the features shown herein but is to be accorded the widest scope consistent with the principles and novel features disclosed herein.

What is claimed is:

1. A method for providing echo cancellation in a wireless repeater in a wireless communication system, comprising:
generating an auxiliary signal with a low power level;
transmitting the auxiliary signal on a transmitting antenna of the wireless repeater, the auxiliary signal being transmitted during a time period without an intended transmit signal;
receiving a receive signal at a receiving antenna of the repeater, the receive signal including at least a feedback signal being a signal fed back to the receiving antenna on a feedback channel between the transmitting antenna and the receiving antenna, the feedback signal including at least the auxiliary signal transmitted on the transmitting antenna of the wireless repeater and fed back to the receiving antenna through the feedback channel;
cancelling the feedback signal from the receive signal using a currently available feedback channel estimate and generating an echo cancelled signal; and
generating an updated feedback channel estimate using the receive signal and a transmit signal based on the echo cancelled signal.

2. The method of claim 1, further comprising:
using the transmit signal as a reference signal in generating the updated feedback channel estimate.

3. The method of claim 1, wherein generating the updated feedback channel estimate using the receive signal and the transmit signal based on the echo cancelled signal comprises:
generating the updated feedback channel estimate using the receive signal and the transmit signal, the transmit signal including at least the echo cancelled signal and the auxiliary signal.

4. The method of claim 1, wherein receiving the receive signal at the receiving antenna of the repeater comprises:
receiving only the auxiliary signal transmitted on the transmitting antenna of the wireless repeater and fed back to the receiving antenna through the feedback channel as the receive signal.

5. The method of claim 4, wherein generating an updated feedback channel estimate comprises:
generating the updated feedback channel estimate using the receive signal containing only the auxiliary signal being fed back through the feedback channel and the transmit signal.

6. The method of claim 1, wherein the auxiliary signal is a white noise signal being about 30 dB above thermal noise, and wherein the auxiliary signal is also transmitted on the transmitting antenna of the wireless repeater during a time period with an intended transmit signal.

7. The method of claim 1, wherein generating the auxiliary signal with a low power level comprises:
generating the auxiliary signal in analog or digital domain; and
adding the auxiliary signal at a point in a signal path between the receiving antenna and the transmitting antenna of the wireless repeater.

8. The method of claim 7, wherein adding the auxiliary signal at the point in the signal path between the receiving antenna and the transmitting antenna of the repeater comprises:
adding the auxiliary signal to a digital or analog transmit circuit of the wireless repeater.

9. The method of claim 7, wherein adding the auxiliary signal at the point in the signal path between the receiving antenna and the transmitting antenna of the repeater comprises:
adding the auxiliary signal to a digital or analog receive circuit of the repeater.

10. The method of claim 1, wherein generating an auxiliary signal with a low power level comprises:
increasing a noise figure of an analog front-end receive circuit.

11. The method of claim 10, wherein increasing a noise figure at an analog front-end receive circuit comprises increasing a thermal noise at the analog front-end receive circuit to be within an input range of an analog-to-digital conversion of the receive circuit.

12. The method of claim 10, wherein increasing the noise figure at the analog front-end receive circuit comprises increasing thermal noise by about 30 dB.

13. A wireless repeater having a receiving antenna and a transmitting antenna, the wireless repeater comprising:
an auxiliary signal construction block configured to generate an auxiliary signal with a low power level, the wireless repeater configured to transmit the auxiliary signal on the transmitting antenna of the wireless repeater during a time period without an intended transmit signal;
an echo canceller configured to receive a receive signal at the receiving antenna of the wireless repeater, the receive signal including at least a feedback signal being a signal fed back to the receiving antenna on a feedback channel between the transmitting antenna and the receiving antenna, the feedback signal including at least the auxiliary signal transmitted on the transmitting antenna of the repeater and fed back to the receiving antenna through the feedback channel, the echo canceller being configured to cancel the feedback signal from the receive signal using a currently available feedback channel estimate and to generate an echo cancelled signal; and
a channel estimation block configured to generate an updated feedback channel estimate using the receive signal and a transmit signal based on the echo cancelled signal.

14. The wireless repeater of claim 13 wherein the channel estimation block is configured to generate the updated feedback channel estimate using the transmit signal as a reference signal.

15. The wireless repeater of claim 13, wherein the transmit signal includes at least the echo cancelled signal and the auxiliary signal.

16. The wireless repeater of claim 13, wherein the receive signal received by the echo canceller comprises only the auxiliary signal transmitted on the transmitting antenna of the wireless repeater and fed back to the receiving antenna through the feedback channel as the receive signal.

17. The wireless repeater of claim 16, wherein the channel estimation block is configured to generate the updated feedback channel estimate using the receive signal containing only the auxiliary signal being fed back through the feedback channel and the transmit signal.

18. The wireless repeater of claim 13, wherein the auxiliary signal is a white noise signal being about 30 dB above thermal noise, and wherein the wireless repeater is configured to also transmit the auxiliary signal on the transmitting antenna of the wireless repeater during the time period with the intended transmit signal.

19. The wireless repeater of claim 13, wherein the auxiliary signal construction block is configured to generate the auxiliary signal in analog or digital domain and add the auxiliary signal at a point in a signal path between the receiving antenna and the transmitting antenna of the wireless repeater.

20. The wireless repeater of claim 19, wherein the auxiliary signal construction block is configured to add the auxiliary signal to a digital or analog transmit circuit of the wireless repeater.

21. The wireless repeater of claim 19, wherein the auxiliary signal construction block is configured to add the auxiliary signal to a digital or analog receive circuit of the repeater.

22. The wireless repeater of claim 13, further comprising:
a first analog front-end circuit configured to receive and transmit signals on the receiving antenna, the first analog front-end circuit further configured to digitize the receive signal received on the receiving antenna; and
a second analog front-end circuit configured to receive and transmit signals on the transmitting antenna, the second analog front-end circuit further configured to digitize the receive signal received on the transmitting antenna,
wherein the auxiliary signal construction block is configured to increase a noise figure associated with a receive circuit in the first or second analog front-end circuit, the increased noise figure being received as the receive signal of the wireless repeater.

23. The wireless repeater of claim 22, wherein at least one of the first and second analog front-end circuits is configured to increase a noise figure associated with a receive circuit by increasing a thermal noise at the respective analog front-end receive circuit to be within an input range of an analog-to-digital conversion of the receive circuit.

24. The wireless repeater of claim 22, wherein at least one of the first and second analog front-end circuits is configured to increase thermal noise by about 30 dB.

25. A computer readable medium having stored thereon computer executable instructions for performing at least the following acts:
generating an auxiliary signal with a low power level;
transmitting the auxiliary signal on a transmitting antenna of a repeater, the auxiliary signal being transmitted during a time period without an intended transmit signal;
receiving a receive signal at a receiving antenna of the repeater, the receive signal including at least a feedback signal being a signal fed back to the receiving antenna on a feedback channel between the transmitting antenna and the receiving antenna, the feedback signal including at least the auxiliary signal transmitted on the transmitting antenna of the repeater and fed back to the receiving antenna through the feedback channel;
cancelling the feedback signal from the receive signal using a currently available feedback channel estimate and generating an echo cancelled signal; and
generating an updated feedback channel estimate using the receive signal and a transmit signal based on the echo cancelled signal.

26. A wireless repeater having a receiving antenna and a transmitting antenna, the wireless repeater comprising:
means for generating an auxiliary signal with a low power level, the auxiliary signal being transmitted on the transmitting antenna of the wireless repeater during a time period without an intended transmit signal;
means for receiving a receive signal at the receiving antenna of the wireless repeater, the receive signal including at least a feedback signal being a signal fed back to the receiving antenna on a feedback channel between the transmitting antenna and the receiving antenna, the feedback signal including at least the auxiliary signal transmitted on the transmitting antenna of the repeater and fed back to the receiving antenna through the feedback channel, the means further for cancelling the feedback signal from the receive signal using a currently available feedback channel estimate and to generate an echo cancelled signal; and
means for generating an updated feedback channel estimate using the receive signal and a transmit signal based on the echo cancelled signal.
